(19) United States
(12) Patent Application Publication
(10) Pub. No.: US 2014/0271068 A1
(43) Pub. Date: Sep. 18, 2014

(54) Cargo Loader for Utility Vehicle

(71) Applicant: Barret Baumann, New Braunfels, TX (US)

(72) Inventor: Barret Baumann, New Braunfels, TX (US)

(73) Assignee: Matt 18:20, LLC, Rockwell, TX (US)

(21) Appl. No.: 13/959,518

(22) Filed: Aug. 5, 2013

Related U.S. Application Data
(60) Provisional application No. 61/801,252, filed on Mar. 15, 2013.

(51) Int. Cl. B60P 1/14

(52) U.S. Cl. CPC B60P 1/14
USPC 414/469

(57) ABSTRACT

A game loader for a vehicle with a wench and a wench cable comprising: a chassis attachment configured to be attachable to a vehicle chassis; a first support member pivotally-connected to the chassis attachment and configured to be selectively movable between an upward position and a lowered position; a game deck rigidly attached to the support member and configured so that the game deck is substantially parallel to the ground when the support member is in the upward position; and a first pulley configured to engage a wench cable, wherein the first pulley is configured so that activating the wench tends to raise the support member from the lowered position to the upward position.

### PRIORITY CLAIMS

This application claims priority to U.S. Provisional Application No. 61/801,252 filed Mar. 15, 2013 which is hereby incorporated by reference.

### BACKGROUND

Hunting deer, hogs, elk, moose, and other large game is a popular activity in North America and throughout the world. Hunters are often alone when harvesting their game. Depending on the game killed, the weight of the animal often exceeds what an individual can easily move.

Many hunters have access to a vehicle such as a utility task vehicle (UTV) or an all terrain vehicle (ATV). While these vehicles are helpful in transporting, harvested game it can still be difficult to load a game carcass onto the vehicle since the bed or rack of the vehicle is typically several feet above ground level. Moreover, many UTVs and ATVs do not come with built-in racks. Others are equipped with racks that are not designed to hold the weight of large game or are not configured to secure the game during transport.

Several designs for ATV lift assist devices have been proposed. However, many prior art designs tend to be overly complicated. Others require components not typically found on UTVs or ATVs.

### SUMMARY

Problems with prior art devices are solved by inventions disclosed herein including an automatic game loader for a vehicle with a wench and a wench cable comprising: a chassis attachment configured to be attachable the vehicle chassis; a first support member pivotally-connected to the chassis attachment and configured to be selectively movable between an upward position and a lowered position; a game deck rigidly attached to the support member and configured so that the game deck is substantially parallel to the ground when the support member is in the upward position; and a first pulley configured to engage a wench cable, wherein the first pulley is configured so that activating the wench tends to raise the support member from the lowered position to the upward position.

Certain embodiments can include additional features such as:
configuration to fit a utility task vehicle.
a lifting tine extending upwardly from a front end of the game deck, wherein the lifting line is configured to contact the ground when the support member is in the lowered position.
a deck support member configured to be attachable to the vehicle, wherein the deck support member comprises a selectively-engagable latch mechanism which, when engaged, is configured to secure the game deck to the vehicle with the support member in the upward position.
a second pulley configured to engage the wench cable.
a cable anchor attachable to the vehicle and configured to accept a hook on the wench cable.
a second support member, pivotally-connected to the chassis attachment at a second location and configured to be selectively movable in parallel with the first support member.

This solution offers many advantages to today's challenges with loaders and front racks. One advantage is that the loader also serves as a front rack for UTVs. Properly constructed, the weight capacity can equal the maximum carrying capacity of the UTV. Preferred features such as an expanded metal deck, a deck rail, and cargo straps allow the game loader to conveniently and securely hold a wide range of cargo.

Another advantage of the disclosed game loader is that the loader uses a winch installed on the UTV to lift cargo. Using a winch to lift heavy cargo, rather than relying on human strength, offers the user convenience and reduces the risk of injury. It also allows users to transport cargo that would otherwise have been unliftable or would have required assistance. Further, wenches configured for installation on the front of UTVs and ATVs are readily available and useful for many other functions.

The disclosed loader has been carefully designed for simple construction and operation. The design is thus advantageous because it can be constructed economically without sacrificing strength and durability. The design also provides for high reliability.

### BRIEF DESCRIPTION OF DRAWINGS

The disclosed inventions are further described and explained in relation to the following drawings wherein:

FIG. 1 is a side elevation view of a UTV with a game loader featuring aspects of the disclosed inventions.

FIG. 2 is a front elevation view of the UTV and game loader of FIG. 1.

FIG. 3 is a side view of the UTV and game loader of FIG. 1 with the game loader in a lowered position.

FIG. 4 is a side view of a game loader for a vehicle.

FIG. 5 is a front view of a game loader for a vehicle.

FIG. 6 is a top view of a game loader for a vehicle.

### DETAILED DESCRIPTION

FIGS. 1-3 illustrates a vehicle 10 with an attached game loader 20 incorporating aspects of the disclosed inventions. The illustrated vehicle is a utility task vehicle (“UTV”). However, some features of the disclosed inventions can be used in combination with other vehicle types. Game loader 20 comprises a rack 22, a pivot attachment 24, and a rack stop 26. Game loader 20 engages a wench 28 and a wench cable 32 attached to vehicle 10. A cable hook 34 is attached to the end of wench cable 32. Pivot attachment 24 is attached to vehicle 10, preferably to chassis 12 near a front end of vehicle 10. Deck stop 26 is also attached to vehicle 10, preferably to roll cage 14. Alternatively, deck stop 26 can be attached to another part of vehicle 10, especially if vehicle 10 lacks a roll cage or if a windshield hinders attachment to roll cage 14.

FIGS. 4-6 provide a closer view of game loader 20. Pivot attachment 24 preferably comprises a metal plate 42 configured to be easily bolted onto chassis 12. Pivot attachment 24 can be configured with a shape and bolt holes or other attachment devices that are specifically designed for a particular model of vehicle 10. Alternatively, pivot attachment 24 can be attached to vehicle 10 by welding. Pivot attachment 24 also comprises joints 44, which are configured to engage support members 52. In the embodiment shown, support members 52 are pivotally-attached to joints 44 by securing a bolt 46 through holes defined in joints 44 and support members 52. The illustrated embodiment comprises a single pivot attachment 24 with two joints 44. However, other numbers of pivot attachments 24 or joints 44 could be used, such as two joints 44 on two separate pivot attachments.

Rack 22 comprises support members 52, which are pivotally-connected to pivot attachment 24 as discussed above. Deck 54 is securely attached to support members 52 preferably by welding. Reinforcing beams 66 are also preferably attached between support members 52 and game deck 54. Deck 54 is shown with optional deck rail 56, which is configured to help keep game or other cargo on deck 54.

Rack 22 also comprises one or more tines 58 attached to a front end of deck 54. Tines 58 are configured so that they are substantially parallel to and level with the ground when rack 22 is lowered. When lifting game or cargo, the item to be lifted is positioned on tines 58, either by manual placement or by using vehicle 10 to position tines 58 under the item. In an alternative embodiment (not shown) axillary securing members can be added to further secure a load prior to lifting. For example, axillary securing members can comprise curved metal poles pivotally attached at forward/upward ends of tines 58. The axillary securing members can be secured at least partially around the cargo, decreasing the likelihood of dropping while lifting.

Rack 22 also comprises a first pulley 72 attached to a first support connector 74, a second pulley 76 attached to a second support connector 78 and a cable anchor 36 (see FIG. 3), attached to vehicle 10 near wench 28. Prior to use, wench cable 32 is positioned around first pulley 72 and second pulley 76, and cable hook 34 is attached to cable anchor 36.

During use, game platform 22 is intended to be selectively movable between a “raised” position, wherein deck 54 is generally parallel to the ground, and a “lowered” position, wherein tines 58 contact the ground. In the raised position, rack 22 is in contact with rack stop 26. Preferably, game platform 22 is secured to rack stop 26 by cotter pin or a similar device to prevent rack 22 from moving during transportation.

When moving rack 22 to the lowered position, first the user should disconnect rack 22 from rack stop 26. Next, the user can lower rack 22 using wench 28. Alternatively, since rack 22 will generally be empty before lowering, the user can lower rack 22 by hand, and connect wench cable 32 after lowering.

When lowered, tines 58 are preferably positioned under a game carcass or other cargo to be lifted. Preferably, straps (not shown) are positioned around the cargo between tines 58 and game deck 54 to help secure the cargo. Wench 28 is then activated, pulling in wench cable 32. As wench cable 32 is wound onto wench 28, a lifting force is applied to first pulley 72, causing rack 22 to be raised. When game platform is fully raised, game deck 54 will rest against deck stop 26 and is preferably secured to deck stop 26 by cotter pins or similar device.

Major components of game loader 20, such as pivot attachment 24, support members 52, deck 54, deck stop 26, reinforcing beam 66 and tines 58 are preferably made from a strong and durable metal such as steel. Additional performance can be obtained using a material with a high strength to weight ratio, such as chromoly steel or aluminum. Metal components can be powder coated to improve corrosion resistance.

Although the invention has been described with reference to specific embodiments, this description is not meant to be construed in a limiting sense. Various modifications of the disclosed embodiments, as well as alternative embodiments of the inventions, will be apparent to persons skilled in the art upon reference to the description of the invention. It is, therefore, contemplated that the appended claims will cover such modifications that fall within the scope of the invention.

What is claimed is:

1. A game loader for a vehicle with a wench and a wench cable comprising:
a chassis attachment configured to be attachable to a chassis the vehicle near the front end of the vehicle;
a first support member pivotally-connected to the chassis attachment and configured to be selectively movable between an upward position and a lowered position;
a game deck rigidly attached to the support member and configured so that the game deck is substantially parallel to the ground when the support member is in the upward position; and
a first pulley configured to engage a wench cable, wherein the first pulley is configured so that activating the wench tends to raise the support member from the lowered position to the upward position.

2. The game loader of claim 1 wherein the vehicle is a utility task vehicle.

3. The game loader of claim 1 further comprising a lifting tine extending upwardly from a front end of the game deck, wherein the lifting line is configured to contact the ground when the support member is in the lowered position.

4. The game loader of claim 1 further comprising a deck support member configured to be attachable to the vehicle, wherein the deck support member comprises a selectively-engagable latch mechanism which, when engaged, is configured to secure the game deck to the vehicle with the support member in the upward position.

5. The game loader of claim 1 further comprising a second pulley configured to engage the wench cable.

6. The game loader of claim 1 further comprising a cable anchor attachable to the vehicle and configured to accept a hook on the wench cable.

7. The game loader of claim 1 further comprising a second support member, pivotally-connected to the chassis attachment at a second location and configured to be selectively movable in parallel with the first support member.

8. A game loader for a vehicle with a wench comprising:
a chassis attachment plate configured to be attachable to a chassis of the vehicle;
two support members pivotally-connected to the chassis attachment plate and configured to be selectively movable between an upward position and a lowered position;
a game deck rigidly attached to the support members;
a first cross bar extending between the two support members and attached to each of the two support members; and
a first pulley attached to the first cross bar and configured to engage a wench cable, wherein the first pulley is configured so that activating the wench tends to raise the support member from the lowered position to the upward position.

9. The game loader of claim 8 further comprising a second pulley configured to engage the wench cable, wherein the first pulley and second pulley are configured so that, when the wench is activated, the support members will be moved from the lowered position to the upward position.

10. The game loader of claim 8 further comprising a lifting tine extending upwardly from a front end of the game deck, wherein the lifting line is configured to contact the ground when the support member is in the lowered position.

11. The game loader of claim 8 further comprising a deck support member configured to be attachable to the vehicle, wherein the deck support member comprises a selectively-engagable latch mechanism which, when engaged, is configured to secure the game deck to the vehicle with the support member in the upward position.

12. The game loader of claim 8 wherein the chassis attachment plate is configured to be attachable to a chassis the vehicle near the front end of the vehicle.

13. The game loader of claim 8 wherein the vehicle is a utility task vehicle.

14. A game loader for a vehicle with a wench comprising:
a chassis attachment plate configured to be attachable to a chassis of the vehicle;
a support members pivotally-connected to the pivot attachment and configured to be selectively movable between an upward position and a lowered position;
a game deck rigidly attached to the support member;
a first pulley configured to engage a wench cable; and
a second pulley configured to engage a wench cable, wherein the first pulley and second pulley are configured so that activating the wench tends to raise the support member from the lowered position to the upward position.

15. The game loader of claim 14 wherein the vehicle is a utility task vehicle.

16. The game loader of claim 14 further comprising a deck support member configured to be attachable to the vehicle, wherein the deck support member comprises a selectively-engagable latch mechanism which, when engaged, is configured to secure the game deck to the vehicle with the support member in the upward position.

17. The game loader of claim 14 further comprising a lifting tine extending upwardly from a front end of the game deck, wherein the lifting line is configured to contact the ground when the support member is in the lowered position.

18. The game loader of claim 14 wherein the chassis attachment plate is configured to be attachable to a chassis the vehicle near the front end of the vehicle.

19. The game loader of claim 14 further comprising a cable anchor attachable to the vehicle and configured to accept a hook on the wench cable.

20. The game loader of claim 14 further comprising a second support member, pivotally-connected to the chassis attachment at a second location and configured to be selectively moveable in parallel with the first support member.
